(19) United States
(12) Patent Application Publication
(10) Pub. No.: US 2026/0192490 A1
(43) Pub. Date: Jul. 9, 2026

(54) METHOD FOR PRODUCING A CERAMIC COMPONENT

(71) Applicant: Manufacture d'Horlogerie Audemars Piguet SA, Le Brassus (CH)

(72) Inventor: Thibaut LE LOARER, Chavannaz (FR)

(73) Assignee: Manufacture d'Horlogerie Audemars Piguet SA, Le Brassus (CH)

(21) Appl. No.: 19/142,613

(22) PCT Filed: Dec. 14, 2023
(86) PCT No.: PCT/IB2023/062657

§ 371 Date: Jun. 23, 2025

(30) Foreign Application Priority Data
Dec. 23, 2022 (EP) 22216574.8

(51) Int. Cl. B28B 11/08; B28B 1/00; B28B 7/34

(52) U.S. Cl. CPC B28B 11/0872; B28B 1/008; B28B 7/34

(57) ABSTRACT

A method for producing a technical ceramic component. Said method notably comprises the following steps: i) arranging in a mould at least one composition of ceramic powder comprising at least one metal oxide; ii) carrying out an SPS sintering cycle in order to obtain a blank of the ceramic component with at least one grey shade on the surface of the component, and iii) machining the blank in order to obtain a predetermined-shaped blank Step iii) is followed by an additional step iv) of performing an oxidation operation on the predetermined-shaped blank in order to reveal at least one colour resulting from the oxidation of said at least one metal oxide, at least on the surface of a first part of the ceramic component the surface of a second part of the ceramic component assuming said at least one grey shade.

### TECHNICAL FIELD

The present invention relates to a method for producing a technical ceramic component, in particular a decorative component in the field of horology or jewellery. The method includes, among other steps, an oxidation operation that allows the production of ceramic components with a greater variety of aesthetic effects without compromising their mechanical properties.

### STATE OF THE ART

In the field of horology, the mechanical performance of watch components, particularly that of a watch case middle, is important in order to withstand unexpected shocks. However, ceramic materials have the disadvantage of being fragile due to their structure. Various methods exist to produce ceramic-based components with improved mechanical performances.

CH718069 discloses a method for producing a ceramic decorative element that provides decorative components with an original appearance while being substantially homogeneous in terms of its structure and mechanical properties. This method includes the steps of: i) preparing a first base composition, comprising a powder intended for a sintering operation to form a ceramic, ii) preparing a second base composition, comprising a powder intended for a sintering operation to form a ceramic, iii) treating at least one of the first and second base compositions, prior to the sintering operation, to introduce at least one pigment and to define respective first and second reactants, iv) placing the first and second reactants in a mould in the form of at least two layers, at least partially adjacent, to define an interface of a predefined form between them, and v) carrying out a sintering operation on the mould containing the first and second reactants.

This method further includes at least one machining step of the ceramic product obtained after the sintering operation, comprising at least one material removal operation along a path intersecting the interface, such that at least a portion of the interface is visible on the surface of the decorative element and the element exhibits variations in tone and/or colour on its surface.

This method has the disadvantage of being complex to implement, as it involves several steps, including the preparation of the powder containing a binder and a stabilizing agent, as well as a debinding step. The complexity of this method consequently has a significant impact on the cost of the produced components.

### BRIEF SUMMARY OF THE INVENTION

An aim of the present invention is therefore to provide a method for producing a technical ceramic component, the implementation of which is simplified compared to the prior art mentioned above.

Another aim of the present invention is to provide a method for producing a technical ceramic component with enhanced mechanical performances.

Another aim of the present invention is to provide a method for producing a technical ceramic component, particularly a watch case middle, that allows the production of components with a greater variety of aesthetic effects without compromising their mechanical properties.

An additional aim of the present invention is to provide a method for producing a technical ceramic component, particularly a watch case middle, that includes a decoration step without the addition of new material.

These aims are at least partially achieved, notably by a method for producing a technical ceramic component, comprising the following steps:
i) arranging in a mould at least one ceramic powder composition containing at least one metal oxide;
ii) carrying out an SPS sintering cycle in order to obtain a blank of the ceramic component in a reduced state with at least one grey shade on the surface of the component; and
iii) machining the blank in order to obtain a predetermined-shaped blank. Step iii) is followed by an additional step iv) of performing an oxidation operation on the predetermined-shaped blank in order to reveal at least one colour resulting from the oxidation of said at least one metal oxide, at least on the surface of a first part of the ceramic component, the surface of a second part of the ceramic component assuming said at least one grey shade.

According to an embodiment, step i) consists in arranging in the mould a first and a second composition, each comprising ceramic powder and a different metal oxide, in order to obtain a first and a second grey shade after step ii).

According to an embodiment, step i) consists in filling the mould with at least three compositions, each comprising ceramic powder and a different metal oxide, in order to obtain three grey shades after step ii).

According to an embodiment, the oxidation operation in step iv) is carry out by a laser beam or a plasma jet supplied by a flow of oxygen.

According to an embodiment, at least one of the laser beam and the plasma jet is used to create patterns with a level of detail whose resolution depends on the beam diameter or, respectively, the effective diameter of the plasma jet.

According to an embodiment, the oxidation operation consists in performing oxidation at least on the surface of a selection of one or more distinct regions of the ceramic component.

According to an embodiment, the oxidation of the said selection of one or more distinct regions of the ceramic component results in the formation of one or more predetermined-shaped patterns, exhibiting at least one colour depending on the metal oxide contained in the oxidized region of the ceramic component.

According to one embodiment, the method further comprises, between steps iii) and iv), a surface treatment operation of at least one region of the predetermined-shaped blank in order to obtain at least one treated surface, wherein the oxidation operation is performed on one or more regions whose surface has been previously treated.

According to an embodiment, a relative movement is induced between the plasma jet, or the laser beam, and the predetermined-shaped blank, while varying the distance between the plasma jet and said blank, respectively the power of the laser beam, in order to obtain a variation in the degree of oxidation on said first part of the ceramic component, so that it displays a gradient of colours.

According to an embodiment, the oxidation operation in step iv) is carry out by placing predetermined-shaped blank in an oxygen or air furnace for a predetermined duration and temperature cycle. The duration and temperature cycle are set so that oxidation occurs, on the one hand, on at least one part of the surface of the blank to obtain a colour dependent on the metal oxide present on the surface of the blank and, on the other hand, within the bulk of the blank to a predetermined depth. The oxidation operation is followed by an operation of selectively removing a layer of oxide to reveal at least one grey shade and/or a gradient of colours.

According to an embodiment, the predetermined temperature cycle includes a temperature ramp-up cycle from approximately 20° C. to a temperature between 800° C. and 1200° C., within a time interval ranging from 3 to 5 hours. The temperature ramp-up cycle is followed by a temperature ramp-down cycle to approximately 20° C., over a time interval ranging from 2 h30 to 3 h30. This makes it possible to oxidize, on the one hand, said at least one part of the surface of the blank to obtain a colour depending on the metal oxide present on the surface, and on the other hand, the underlying material to a depth ranging from 50 to 300 micrometres.

According to an embodiment, the material is removed, according to a predetermined pattern, to a depth extending beyond that of the oxidized bulk of the blank, in order to reveal one or more grey shades.

According to an embodiment, the material is removed, according to a predetermined pattern and a variable depth, along a trajectory within the oxidized bulk in order to reveal a gradient of colour.

According to an embodiment, the SPS sintering cycle is carried out at a temperature between 1100° C. and 1300° C. within a time interval ranging from 10 to 45 minutes.

Another aspect of the invention relates to a component for a watch or jewellery piece obtained by the aforementioned method, in particular a watch case middle or a watch bezel.

### BRIEF DESCRIPTION OF THE FIGURES

Examples of embodiments of the invention are provided in the description, illustrated by the appended figures, in which:

FIGS. 1a to 1e illustrate schematic views of a watch case middle during the various stages of its manufacturing, according to an embodiment;

FIGS. 2a to 2e illustrate schematic views of a watch case middle during the various stages of its manufacturing, according to another embodiment;

FIGS. 3a to 3d illustrate schematic views of a watch case middle during the various stages of its manufacturing, and FIGS. 4a and 4b illustrate a final decoration step according to two examples, according to another embodiment;

FIGS. 5a to 5d illustrate schematic views of a watch case middle during the various stages of its manufacturing, according to another embodiment;

FIGS. 6a to 6e illustrate schematic views of a watch case middle during the various stages of its manufacturing, according to another embodiment;

FIG. 7 is a schematic top view of the watch case middle from FIG. 6e during the oxidation process, which generates a colour gradient through the projection of an oxygen plasma via a plasma jet using a nozzle;

FIG. 8 is a graph illustrating the relationship between the oxidation degree of the watch case middle and the distance between the nozzle and the watch case middle, and

FIG. 9 illustrates the watch case middle from FIG. 7, showing a colour gradient in its central portion according to the oxidation degree and the distance between the nozzle and the central portion of the case middle.

### EXAMPLES OF EMBODIMENTS OF THE INVENTION

The following description focuses on describing a method for producing a technical ceramic component in the fields of horology or jewellery, according to various embodiments chosen as non-limiting examples. More specifically, the ceramic component manufactured by implementing the method, according to any of the embodiments described below, is a watch case middle. Of course, one skilled in the art can apply the same method for producing other ceramic components without departing from the scope of the invention.

In the context of the present invention, the term “colour” refers to colours other than the palette of grey shades. A colour or colour palette, in the context of the present invention, relates to the visual appearance imparted to the surface or a visible part of a ceramic component that has been revealed by an oxidation operation. The palette of colours that can be obtained depends on the metal oxides present in the ceramic powder. Furthermore, the term “at least one shade of grey” refers to the visual appearance imparted to the surface of a ceramic component once the ceramic powder has undergone an SPS sintering cycle to obtain a blank of the ceramic component in a reduced state, without being subjected to an oxidation operation. The shade of grey is one of the tones that, to the human eye, appears to be between white and black.

Generally, the method for manufacturing a watch case middle comprises two steps common to the embodiments described below. The first step involves placing at least one composition of ceramic powder containing at least one metal oxide into a mould. This step is followed by a second step involving a flash sintering operation, or “Field Assisted Sintering Technique/Spark Plasma Sintering (FAST/SPS)”. More commonly known as SPS sintering, this operation is a method similar to hot isostatic pressing but uses the Joule effect to heat pre-compacted powder within a mould placed between two graphite electrodes in an inert atmosphere or under vacuum, the mould containing the pre-compacted powder being subjected to a pressure of several megapascals under the action of a hydraulic press. A continuous or alternating current of several kiloamperes, pulsed or not, is applied between the electrodes with a voltage of a few volts.

The plasma during sintering ionizes the residual gas between the powder particles and generates negative ions that consume all the oxygen from the metal oxide contained in the ceramic powder. Although the sintering operation is typically performed under vacuum or in an inert atmosphere, this ionization of the residual gas thus creates a so-called reducing atmosphere within the plasma. Due to this reducing atmosphere, the resulting component, once the flash sintering operation is complete, is consequently necessarily in a reduced state.

SPS sintering is performed at a determined sintering temperature and pressure such that none of the powders melt. The sintering pressure may, in this case, be a mechanical pressure. Preferably, the sintering temperature is determined so that it remains lower than the lowest melting temperature of the powders under sintering conditions. The appropriate sintering temperature can be evaluated based on the sintering pressure in order to avoid reaching or exceeding, or to remain lower than, the melting temperatures of the powders at the sintering pressure.

According to one embodiment, the SPS sintering temperature is below 2000° C., or even below 1500° C. For example, the SPS sintering temperature is between 1000° C. and 1300° C. over a time interval of 10 to 45 minutes.

The SPS sintering pressure can range from 20 to 180 N/mm² or from 50 to 100 N/mm² . Other pressure values may be preferred depending on the selected components and/or the required quality of the final mechanical component.

The SPS sintering operation results in a sintered component that preserves the fine granularity of the ceramic, which has the advantage of optimizing mechanical properties, particularly hardness and toughness, compared to a conventional sintering cycle. Since sintering is carried out in an inert atmosphere or under vacuum, the resulting sintered component is in a reduced state, and its shape is determined by the final shape of the component.

According to the example of a watch case middle, the shape of the sintered blank is substantially cylindrical with a diameter that can range between 40 mm and 60 mm, for example approximately 50 mm, and a thickness ranging from 15 mm to 20 mm, for instance 18 mm.

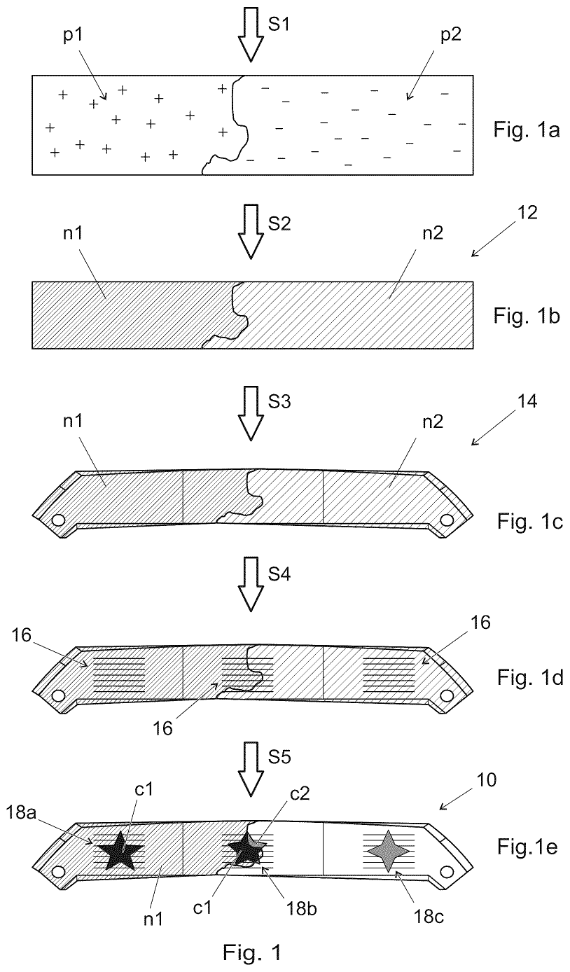

According to a first embodiment and with reference to FIGS. 1a to 1e, the method for manufacturing the ceramic watch case middle 10 comprises a first step S1 consisting in placing a first and a second composition p1, p2 into a mould (not illustrated), each comprising ceramic powder, preferably zirconia, particularly yttrium-stabilized zirconia, and at least one different metal oxide, preferably selected from iron oxide, aluminium oxide, bismuth oxide, and chromium oxide.

The first and second compositions p1, p2 are distributed in the mould without being mixed, as illustrated in FIG. 1a. More specifically, the first and second compositions p1, p2 are placed next to each other to form an interface between them, extending in a direction that can be substantially perpendicular to the bottom of the mould.

In a second step S2, an SPS sintering operation is performed to obtain a blank 12 of the watch case middle, as shown in FIG. 1b, which has two shades of grey n1, n2 on its surface meeting at an interface that may be substantially perpendicular to the general mid-plane of the watch case middle 10. In a non-illustrated variant, three, four, or even five different compositions, or more, are arranged side by side to obtain, after the SPS sintering operation, a blank of the watch case middle with as many or a plurality of shades of grey on the surface, so that their respective interfaces extend, preferably, substantially perpendicularly to the general mid-plane of the watch case middle.

In another non-illustrated variant, at least two different compositions, such as three, four, or even five compositions, or more, are distributed in the mould to form as many or a plurality of distinct superposed layers. A blank of the watch case middle, having two, three, four, or even five shades of grey or more, meeting at respective interfaces that may be substantially parallel, is thus obtained after the SPS sintering operation. These interfaces can be essentially parallel or inclined relative to the general plane of the watch case middle.

Each composition p1, p2 may contain one or more different metal oxides, including, for example, iron oxide, aluminium oxide, cerium oxide, bismuth oxide, and chromium oxide. The two compositions p1, p2 may each represent a substantially equivalent volume. The compositions p1, p2 are disposed in the mould relative to one another based on the desired location of the different shades of grey n1, n2 on the finished component. The compositions p1, p2 may also differ in terms of their ceramic powders, for example, with composition p1 being based on zirconia and composition p2 based on alumina or another material.

Once the SPS sintering operation is completed, the method comprises a third step S3 consisting in machining the blank 12 to obtain a predetermined-shaped blank 14, which generally corresponds to the final dimensions of the ceramic component, i.e., the shape of a watch case middle in this case, as illustrated in FIG. 1c. The machining is carried out using conventional means, notably milling and/or grinding.

The method may comprise a surface treatment step S4 as shown in FIG. 1d. This step, which is optional, consists in performing a decoration on one or more regions of the surface of the component, particularly on the side of the watch case middle, through a mechanical and/or chemical operation. The mechanical operation may include polishing, sandblasting, straight-line, circular, or spiral satin finishing, microbeading, guilloché, circular graining, Côtes de Genève finishing, or hand engraving. In this example, the machined blank 14 has undergone a surface treatment to comprise one or more surfaces 16 with decoration obtained by one of the aforementioned mechanical operations.

For components comprising several regions separated from each other that have undergone surface treatment, the same type of treatment may be applied to all regions, such as sandblasting or, according to a variant, the treatment may vary from one region to another, for example, sandblasting for a first region, satin finishing for a second region, and polishing for a third region. According to another variant, these different regions may be adjacent.

The method comprises a final step, S5, consisting in decorating the blank, for example as illustrated schematically in FIG. 1e. This decoration step S5, consists in performing an oxidation operation on at least a part of the watch case middle, particularly on its flank, to reveal the colour of the metal oxide on the surface of the component. According to FIG. 1e, the oxidation operation consists in selectively oxidizing the surface of the watch case middle 10, for example to a depth of 50 micrometres, so that the shape of the oxidized surface matches the desired pattern. This operation triggers a chemical reaction initiated by oxygen coming into contact with the metal oxide(s) present on the surface of the component. This reaction allows the different oxides to reveal their vivid colours. Consequently, this final operation is a chemical transformation of the material, unlike the method described in CH718069, where the final step consists in removing material using a CNC machine or a laser.

The patterns 18a, 18b, 18c, represented in this example by three stars, exhibit different colours. The first star 18a displays a colour specific to the metal oxide(s) present in the first composition p1, the second star 18b exhibits two distinct colours corresponding to the metal oxide(s) present in the first composition p1 and in the second composition p2 respectively while the third star 18c exhibits another colour specific to the metal oxide(s) in the second composition p2.

As an example, the compositions p1 and p2 may respectively contain bismuth oxide and aluminium oxide to obtain a blank as shown in FIG. 1b, where the compositions p1 and p2 in their reduced state have a dark grey and light grey shade respectively. The shade of dark grey and light grey can vary depending on the concentration of the oxides in the two compositions. After the oxidation step illustrated in FIG. 1e, the first pattern 18a will have a homogeneous colour c1 tending toward blue to varying intensities depending on the concentration of bismuth oxide. The third pattern 18c will have colour c3 tending toward white to varying intensities depending on the concentration of aluminium oxide, while the second bicolour pattern will have a combination of the two previously mentioned colours.

The watch case middle 10 obtained according to this first embodiment therefore has two shades of grey n1, n2 on the surface, along with different decorations 18a, 18b, 18c, which are represented as stars in this example and possess vivid colours depending on the oxide(s) present on the surface at the locations of these stars. The stars 18 are preferably created on the regions of the watch case middle that have undergone a surface treatment 16, as previously described, to provide additional contrast to the decorations 18a, 18b, 18c. The decorations can also be applied to regions of the watch case middle that have not undergone surface treatment beforehand, according to a non-illustrated variant.

The oxidation operation can, for example, be carried out using a laser source, where the localized heat enables the creation of a localized oxide layer. The laser source can be controlled in such a way that the laser follows a predefined path on the surface of the watch case middle 10 reproducing a pattern, such as a repetitive pattern or even text.

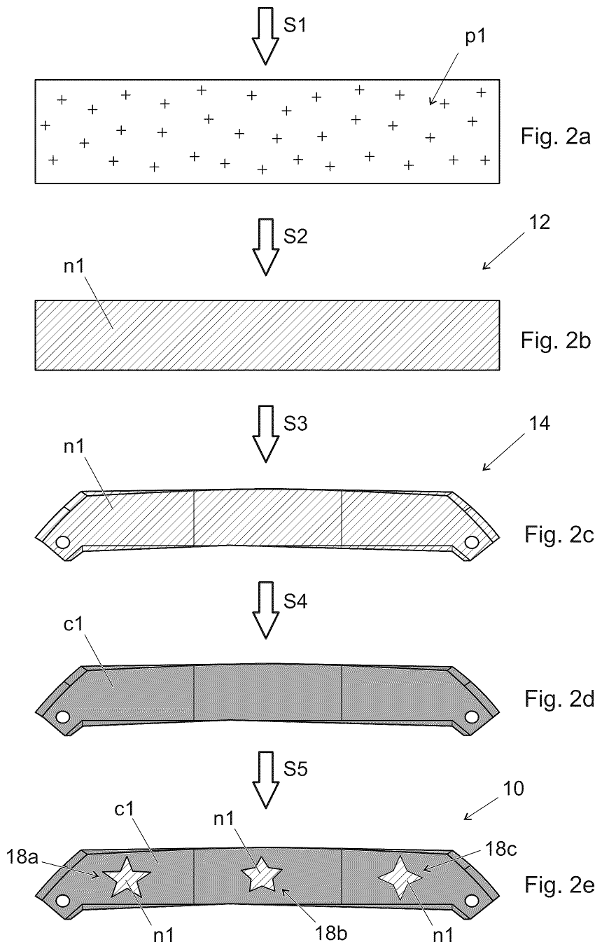

According to a second embodiment, and with reference to FIGS. 2a to 2e, the method for manufacturing the ceramic component comprises a first step S1 consisting in filling the mould (not illustrated) with a single composition p1 comprising one or more metal oxides, followed by performing, during a second step S2, an SPS sintering operation, as described in reference to the first embodiment, to obtain a blank 12 of the watch case middle in the form of a disk in its reduced state. The visual appearance of the ceramic at this point exhibits only a single homogeneous grey shade n1 as illustrated in FIG. 2b.

As in the first embodiment, the method comprises a third step S3, consisting in machining the blank 12 of the watch case middle to its final dimensions once the sintering operation has been completed, as illustrated in FIG. 2c.

The operation of decorating the machined blank 14 consists, in this embodiment, of two steps. The preliminary step S4 consists in performing an oxidation operation on at least a part of the surface of the blank. Preferably, the entire surface of the blank is oxidized.

To do this, the machined blank 14 is placed in a furnace under oxygen or air for a predetermined duration and temperature cycle so that oxidation occurs, on the one hand, at the surface of the blank of the component to obtain a colour associated with the type of metal oxide(s) present on the surface of the component and, on the other hand, within the mass of the component, i.e. at least to a certain depth that can no longer be considered part of the surface of the component. Step S4 is a chemical transformation of the material, particularly at the surface of the blank. This step is distinct from the previous step S3 consisting in machining the blank 12 of the watch case middle to its final dimensions. This contrasts with the method described in CH718069, where the final step consists in removing material using a CNC machine or a laser. a temperature ramp-up cycle from approximately 20° C. to a temperature between 800° C. and 1200° C. within a time interval ranging from 3 to 5 hours, followed by a temperature ramp-down cycle to approximately 20° C. over a time interval ranging from 2 h30 to 3 h30,

The predetermined temperature cycle typically includes a temperature ramp-up cycle from approximately 20° C. up to a temperature between 800° C. and 1200° C., preferably around 1000° C., within a time interval of 3 to 5 hours, preferably around 4 hours. The temperature ramp-up cycle is followed by a temperature ramp-down cycle to approximately 20° C. within a time interval of 2.5 to 3.5 hours, preferably around 3 hours. This temperature cycle makes it possible to oxidize, on the one hand, the surface of the blank to obtain a single homogeneous colour c1 associated with the type of metal oxide(s) present on the surface of the blank, and, on the other hand, the underlying material to a thickness preferably between 50 and 300 micrometres.

The oxidation operation is followed by step S5, which aims to selectively remove the entire thickness of the oxide layer on the surface of the component and near the surface according to one or more any decorative shapes, which are three stars 18a, 18b, 18c in this example, in order to reveal the ceramic in its reduced state beneath the oxide layer, corresponding to a grey shade n1.

The selective removal of the oxide layer can, for example, be done through conventional machining or, for highly detailed patterns, by using a laser source as machining tool.

The watch case middle 10 obtained by the method according to this embodiment thus has an overall visual appearance comprising a substantially homogeneous surface tinted with a vivid colour depending on the metal oxide(s) on the surface of the component, as well as one or more decorations 18a, 18b, 18c revealing a grey shade n1, which corresponds to the underlying ceramic in its reduced state.

According to a non-illustrated variant, the depth of material removal varies through the thickness of the oxide layer along a trajectory to reveal a gradient of colours corresponding to different degrees of oxidation of the oxide(s) present in the composition p1.

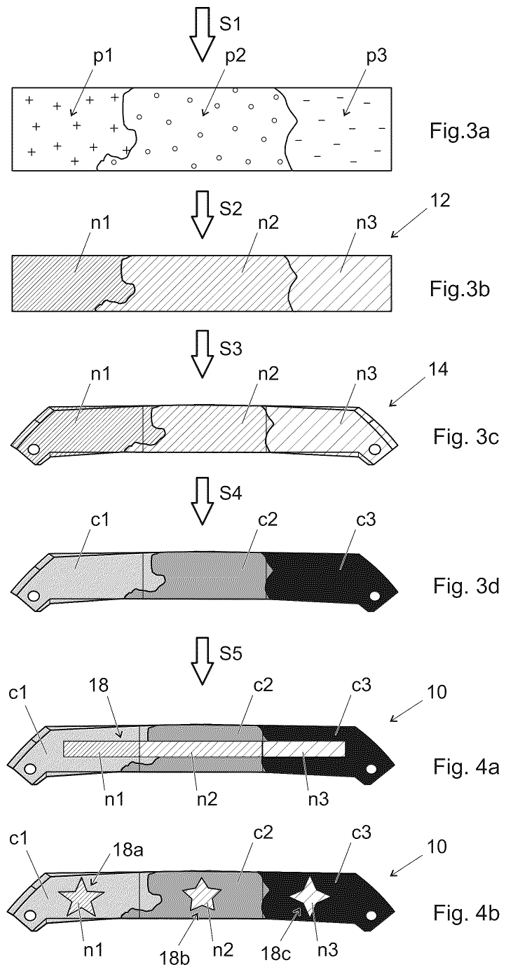

According to a third embodiment, and with reference to FIGS. 3a to 3d, the method for manufacturing the ceramic component comprises a first step S1 consisting in filling the mould (not illustrated) with three compositions p1, p2, p3, each comprising ceramic powder, preferably zirconia, particularly yttrium-stabilized zirconia, and at least one different metal oxide. The three compositions, p1, p2, p3 are distributed in the mould without being mixed. Each composition, p1, p2, p3 may contain one or more different metal oxides.

An SPS sintering operation, S2, is performed, according to the method described with reference to the first embodiment, to obtain a blank 12 of the watch case middle in its reduced state as illustrated in FIG. 3b. The SPS sintering operation reveals three homogeneous grey shades n1, n2, n3 which converge at two interfaces. A machining operation S3 is performed on the sintered component to obtain the final dimensions of the predetermined-shaped blank 14 of predetermined shape of the watch case middle, as shown in FIG. 3c.

An oxidation operation S4, is then performed on the entire surface of the blank 14 as shown in FIG. 3d. The oxidation of the areas revealing the three grey shades results in the appearance of three different vivid colours c1, c2, c3. As with the first two embodiments, step S4 is a chemical transformation of the material on the surface of the blank. This step is distinct from the previous step S3 consisting in machining the blank 12 of the watch case middle to its final dimensions.

The oxidation operation is followed by an operation S5 consisting in selectively removing the oxide layer to form a decoration comprising one or more patterns. FIGS. 4a, 4b illustrate a watch case middle 10, obtained by the method according to this embodiment, with a general surface possessing three distinct vivid colours and two examples of decoration. The case middle 10 shown in FIG. 4a comprises a decoration on its side in the form of a groove 18, along which the three grey shades, n1, n2, n3 appear successively. The case middle 10 in FIG. 4b comprises a decoration on its side in the form of three distinct patterns, for example, three stars 18a, 18b, 18c, revealing three grey shades n1, n2, n3 respectively.

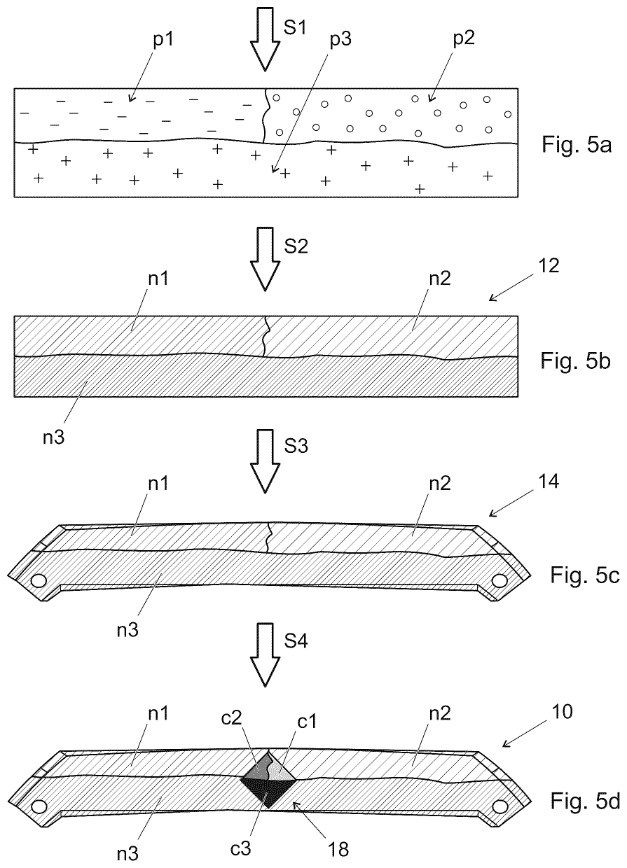

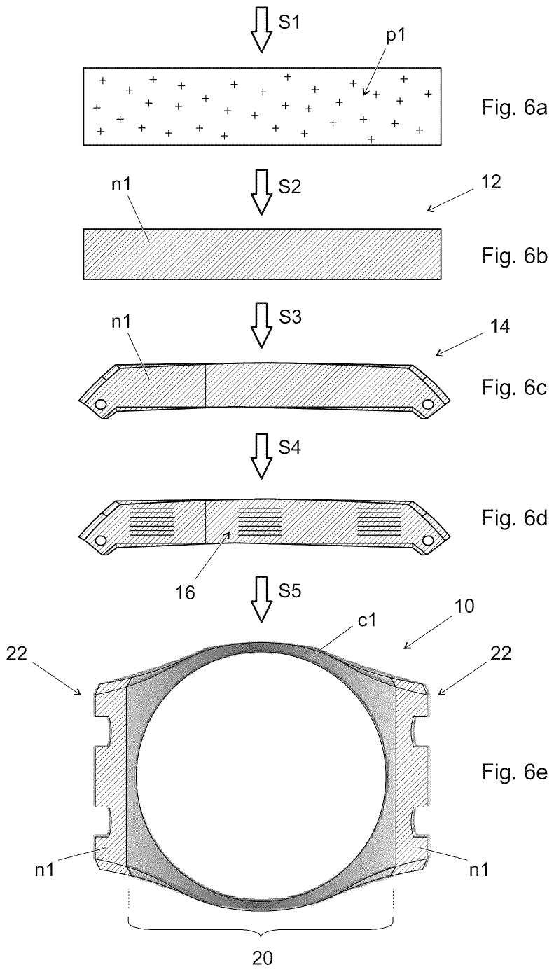

FIGS. 5a to 5d illustrate a fourth embodiment, where the first three steps, S1, S2, and S3, are identical to the first three steps of the embodiment previously described. The surface of the predetermined shaped blank 14, shown in FIG. 5c, is then selectively oxidized in step S4 according to one or more any patterns 18 to create a decoration in a region containing the three grey shades, n1, n2, n3. The oxidation enables the revelation of three vivid colours c1, c2, c3 specific to the type of the metal oxide(s) present in the different compositions p1, p2, p3. This chemical transformation of the material on the surface of the blank 14 is also distinct from the previous step S3 consisting in machining the blank of the watch case middle to its final dimensions.

The watch case middle 10 obtained by the method according to this embodiment has a general visual appearance comprising a surface with three grey shades n1, n2, n3 as well as one or more decorations revealing three vivid colours c1, c2, c3.

According to another embodiment illustrated by FIGS. 6a to 6e, the first three steps, S1, S2, S3 are identical to the first three steps of the method according to the second embodiment. The machining step S3 may be followed by an optional step S4 consisting in performing a surface treatment, as described earlier, to obtain one or more surfaces with a specific finish on the side of the watch case middle. The machining step S3 or the surface treatment step S4 is followed by an oxidation step S5 on a central portion 20 of the watch case middle by projecting an oxygen plasma flow. The resulting watch case middle 10 has a general surface of a vivid colour c1, and a grey shade n1 on a portion 22 including the horns.

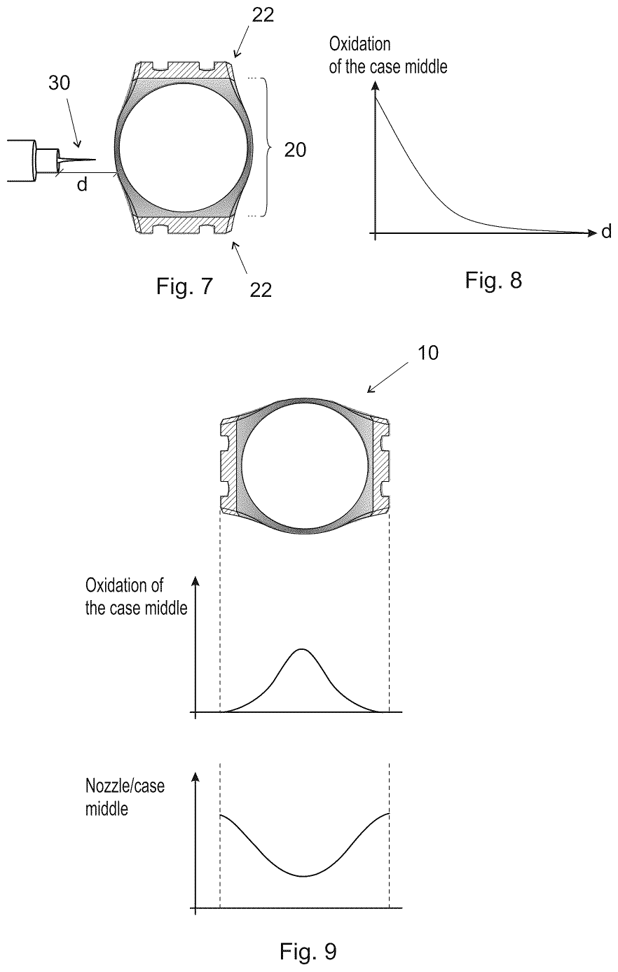

Referring to FIGS. 7-9, the projection of an oxygen plasma flow is carried out using a nozzle that generates a plasma jet 30. The watch case middle 10 or the plasma jet 30, in particular the nozzle from which the jet is emitted, can be moved to induce relative motion of the plasma flow projection over the central portion 20 of the watch case middle. In an advantageous embodiment, the nozzle or the case middle 10 can be moved so as to vary the distance between the plasma jet 30 and the watch case middle, more specifically between the effective diameter of the plasma jet, which is essentially conical, and the watch case middle, and in practice the distance d between the nozzle and the case middle. This variation in distance allows for, on the one hand, a variation in the degree of oxidation on the central portion 20 so that it features a colour gradient and, on the other hand, a grey shade on the horns 22.

It should be noted that, regardless of the contemplated embodiment, the use of a laser beam and/or plasma jet 30 to carry out the oxidation operation can be employed both to obtain chosen or even random patterns, as well as flat areas on the surface of the predetermined-shaped blank 14. Such flat areas may consist of surfaces or zones that are either uniform, gradient, or mixed. The same applies to the aforementioned patterns, which could also be entirely or partially created outside or within these areas.

Although the method has been primarily described for the manufacture of a technical ceramic watch case middle, it can be applied to other ceramic components without departing from the invention as defined by the claims. This method can, for example, be applied to any type of horological component, particularly to components of a watch movement intended to be visible from the back of a watch case through a sapphire glass, or to decorative components in both the horology and jewellery fields.

1. Method for producing a technical ceramic component, comprising the following steps:
i) arranging in a mould at least one composition of ceramic powder comprising at least one metal oxide;
ii) carrying out an SPS sintering cycle in order to obtain a blank of the ceramic component with at least one grey shade on the surface of the component;
iii) machining the blank in order to obtain a predetermined-shaped blank;
wherein step iii) is followed by an additional step iv) of performing an oxidation operation on the predetermined-shaped blank in order to reveal at least one colour resulting from the oxidation of said at least one metal oxide at least on the surface of a first part of the ceramic component, the surface of a second part of the ceramic component assuming said at least one grey shade.

2. Method according to claim 1, wherein step i) consists in arranging in the mould a first and a second composition, each comprising ceramic powder and a different metal oxide, in order to obtain a first and a second grey shade after step ii).

3. Method according to claim 1, wherein step i) consists in filling the mould with at least three compositions each comprising ceramic powder and a different metal oxide, in order to obtain three grey shades after step ii).

4. Method according to claim 1, wherein the oxidation operation in step iv) is carry out by a laser beam or a plasma jet (30) supplied with an oxygen flow.

5. Method according to claim 4, wherein at least one of the laser beam and the plasma jet is used to create patterns with a level of detail whose resolution depends on the beam diameter or, respectively, the effective diameter of the plasma jet (30).

6. Method according to claim 4, wherein the oxidation operation consists in performing oxidation at least on the surface of a selection of one or more distinct regions of the ceramic component.

7. Method according to claim 6, wherein the oxidation of said selection of one or more distinct regions of the ceramic component results in the formation of one or more predetermined-shaped patterns, exhibiting at least one colour depending on the metal oxide contained in the oxidized region of the ceramic component.

8. Method according to claim 5, further comprising, between steps iii) and iv), a surface treatment operation on at least one region of the predetermined-shaped blank in order to obtain at least one treated surface, wherein the oxidation operation is performed on one or more regions whose surface has been previously treated.

9. Method according to claim 4, wherein a relative movement is induced between the plasma jet, or the laser beam, and the predetermined-shaped blank, while varying the distance between the plasma jet and said blank, respectively the power of the laser beam, in order to obtain a variation in the degree of oxidation on said first part of the ceramic component so that it displays a gradient of colours.

10. Method according to claim 1, wherein the oxidation operation in step iv) is carry out by placing the predetermined-shaped blank in an oxygen or air furnace for a predetermined duration and temperature cycle so that oxidation occurs, on the one hand, on at least one part of the surface of the blank to obtain a colour depending on the metal oxide present on the surface of the blank and, on the other hand, within the bulk of the blank to a predetermined depth, the oxidation operation being followed by an operation of selectively removing a layer of oxide in order to reveal at least one grey shade and/or a gradient of colours.

11. Method according to claim 10, wherein the predetermined temperature cycle includes a temperature ramp-up cycle from approximately 20° C. to a temperature between 800° C. and 1200° C. within a time interval ranging from 3 to 5 hours, followed by a temperature ramp-down cycle to approximately 20° C. over a time interval ranging from 2 h30 to 3 h30, in order to oxidize, on the one hand, said at least one part of the surface of the blank to obtain a colour depending on the metal oxide present on the surface, and on the other hand, the underlying material to a depth ranging from 50 to 300 micrometres.

12. Method according to claim 10, wherein the material is removed, according to a predetermined pattern, to a depth exceeding that of the oxidized bulk of the blank, in order to reveal one or more grey shades.

13. Method according to claim 10, wherein the material is removed, according to a predetermined pattern and a variable depth, along a trajectory within the oxidized bulk in order to reveal a colour gradient.

14. Method according to claim 1, wherein the SPS sintering cycle is performed at a temperature between 1100 and 1300° C. and within a time interval ranging from 10 to 45 minutes.

15. Component for a timepiece or jewellery piece obtained by the method according to claim 1.
